(19) United States
(12) Patent Application Publication
(10) Pub. No.: US 2004/0201450 A1
(43) Pub. Date: Oct. 14, 2004

(54) Integrated reader device for use in controlling secure location access and a method of assembly and installation of the integrated reader device

(75) Inventors: Gene Samburg, Arlington, VA (US); Jaimie Crafton, Centreville, VA (US)

Correspondence Address: NIXON PEABODY, LLP, 401 9TH STREET, NW, SUITE 900, WASHINGTON, DC, 20004-2128, US

(73) Assignee: KASTLE SYSTEMS INTERNATIONAL LLC, Arlington, VA

(21) Appl. No.: 10/820,708

(22) Filed: Apr. 9, 2004

Related U.S. Application Data
(60) Provisional application No. 60/461,837, filed on Apr. 11, 2003.

(51) Int. Cl. G05B 19/00

(52) U.S. Cl. 340/5.61; 340/5.2

(57) ABSTRACT

In accordance with the present invention, an integrated reader device for installation near a controlled access entrance is disclosed as well as a method for forming and installing an integrated reader device. The integrated reader device includes a non-metallic mounting frame, a glass insert mounted on an inside edge of the non-metallic frame, a proximity reader mounted to one side of said mounting frame and over the glass insert, and a plurality of LED strips mounted on the inside edge of the non-metallic mounting frame, wherein the integrated reader device is installed to the edge of an opening.

The present invention claims benefit of priority to U.S. Provisional Application No. 60/461,837 filed Apr. 11, 2003 and is hereby incorporated by reference in its entirety.

### FIELD OF THE INVENTION

The present invention is directed to an integrated reader device that provides access control with regard to a secured area, and more specifically to a method of assembling the integrated reader device for easy and efficient installation adjacent the secured area.

### BACKGROUND OF THE INVENTION

In today's quickly evolving society, the ability to provide a secure business environment is becoming more and more important. Many organizations are spending millions of dollars purchasing very sophisticated access control systems to ensure that their employees, equipment and intellectual property is safe from theft and bodily harm from interests external to the organization. Additionally, companies are spending large amounts of money to protect employees, equipment and intellectual property from interests internal to the organization. For example, employees that do not need access to a location due to their position in the organization may be prevented access to certain areas of the organization's facility. Thus, many physical locations within an organization's building or campus have varying amounts of security to prevent improper access by both employees and non-employees. As these systems become more complex, additional expense is required to install the systems, as well as to ensure their reliability.

While the access control systems purchased by organizations are intended to provide selective access to physical areas for certain individuals, the organizations usually want to minimize and downplay the fact that security measures have been implemented. This is done for several reasons. With regard to visitors, many businesses and organizations would like to evoke feelings of comfort and security without the visitor feeling intimidated or uncomfortable. Additionally, the businesses and organizations do not want the full extent of its security measures readily apparent to potential intruders. As a result, most organizations wish to ensure that any visible security measures either blend in to the environment or are as aesthetically pleasing as possible to the passerby. To ensure this, the manner in which the viewable hardware of these systems is put together and installed has become much more important.

With the various technical backgrounds necessary for the installation of security systems and, more specifically for reader devices, it is not uncommon for different sub-contractors to be employed in installing different parts of the reader devices used in security systems. For example, one sub-contractor having expertise in drywall installations may be needed to insure that any modifications to the walls adjacent to secure entrances are minimized as well as making any necessary penetrations and framing in the drywall for installation of reader devices. Another sub-contractor, with expertise in installing the hardware associated with the security system such as door locks, reader devices and the like might be needed to install the specific reader devices in the walls and integrate the reading devices to the remainder of the system. Additional personnel may be needed to install the controllers such as computers and the like.

Due to the number of different people that may be required to install such a system, this can invariably lead to large expenses as well as errors in the installation of the reader device. For example, the contractor creating the opening in the wall for the reader device might make the necessary opening, then move on to his/her next job. When the contractor responsible for installing the reader device attempts to install the reader device, it is quite possible that the reader device might not fit (due to measurement errors, for example). Most likely the person hired to install the reader device will now be required to modify the hole in the wall as well as the required framing. Thus, a person with no experience could be modifying an opening and associated frame in the drywall in order to properly position the reader device. These required additional tasks demand additional time and invariably reduce the aesthetics surrounding the reader and the entire security system.

### SUMMARY OF THE INVENTION

Accordingly, the present invention solves the aforementioned problems by providing an integrated illuminated reader device that includes a non-metallic frame directly attached to the reader prior to installation that can be easily installed in a wall and emits a visually appealing light when activated.

More specifically, and in accordance with an exemplary embodiment of the present invention, an integrated reader device for installation near a controlled access entrance is provided that includes a non-metallic mounting frame, a glass insert mounted on an inside edge of the non-metallic frame, a proximity reader mounted to one side of said mounting frame and over the glass insert, and a plurality of LED strips mounted on the inside edge of the non-metallic mounting frame, wherein the integrated reader device is installed.

In accordance with another exemplary embodiment of the present invention, a method for forming and installing an integrated reader device that includes a proximity reader, a glass panel and a non-metallic frame is employed. The steps of forming and installing the integrated reader device include inserting the glass panel into the non-metallic frame, wherein the glass panel is formed by attaching a first glass section to a second glass section with an adhesive. An acrylic layer is then attached to the second glass section. A plurality of LED strips are attached to the non-metallic frame and the integrated proximity reader is formed by attaching the proximity reader over the acrylic layer of the glass panel and to the frame. Finally, the integrated proximity reader is installed on the edge of an opening of a predetermined size.

In yet another exemplary embodiment of the present invention, the non-metallic frame is attached at the carved step in the edge of the second glass panel. In an additional exemplary embodiment of the present invention, an adhesive is applied to a front the non-metallic frame, and the adhesive covered frame is attached to the edge of the opening.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 depicts a system for providing secure access in which a proximity reader can be employed in accordance with an exemplary embodiment of the present invention;

FIG. 2 illustrates a side view of the integrated reader device provided in accordance with an exemplary embodiment of the present invention;

FIGS. 3A and 3B illustrate front and side views, respectively, of the glass insert portion of the integrated reader device provided in accordance with an exemplary embodiment of the present invention;

FIGS. 4A, 4B and 4C illustrate front, side and rear views, respectively, of the non-metallic mounting frame portion of the integrated reader device provided in accordance with an exemplary embodiment of the present invention;

FIGS. 5A and 5B illustrate flow diagrams describing the manner in which the integrated reader device is constructed and installed in accordance with an exemplary embodiment of the present invention; and

FIGS. 6A and 6B illustrate front and side views, respectively, of the proximity reader device installed in a wall, in accordance with an exemplary embodiment of the present invention.

### DETAILED DESCRIPTION

The exemplary systems and the methods of this invention will be described in relation to an integrated reader device, its assembly and its installation. However, to avoid unnecessarily obscuring the present invention, the following description omits well-known structures and devices that may be shown in block diagram form or otherwise summarized. For the purpose of explanation, numerous specific details are set forth in order to provide a thorough understanding of the present invention. It should be appreciated however that the present invention may be practiced in variety of ways beyond the specific details set forth herein.

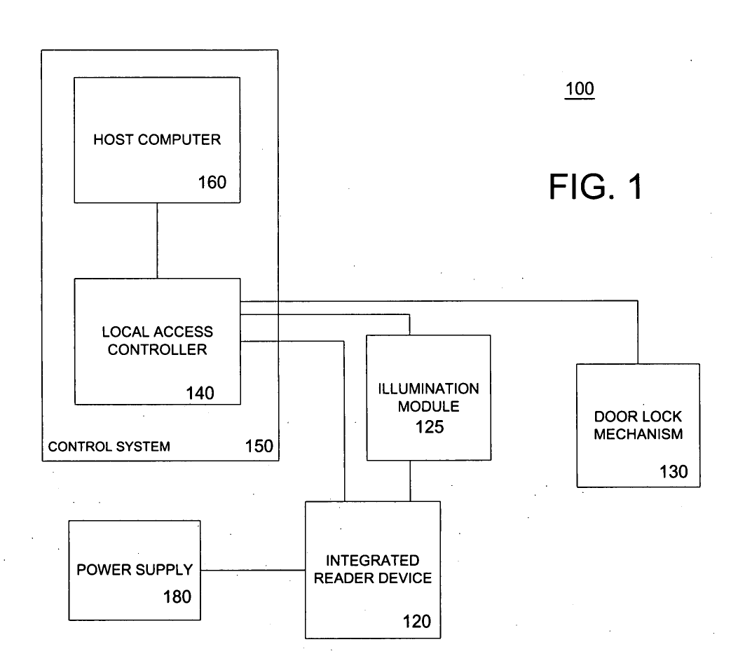

FIG. 1 illustrates a block diagram of a security access system 100 that employs the integrated reader device of the present invention. In accordance with the present invention, the security access system 100 includes an integrated reader device 120, an illumination module 125, a door locking mechanism 130, a power supply 180 and a control system 150 which includes an local controller 140 and a host computer 160.

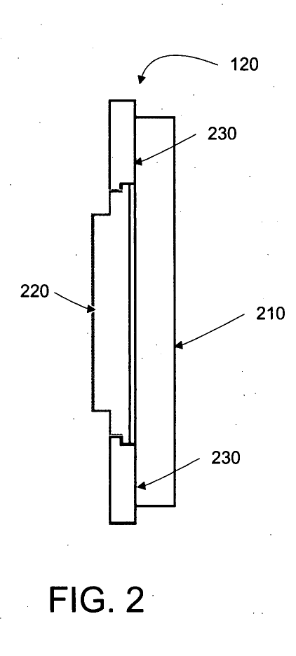

The reader device 120 can be mounted within a wall or similar non-metallic structure such as a stanchion, pylon, or the like adjacent to an entrance to a secure area. The exact make-up and assembly of which is discussed in more detail below with regard to FIGS. 2-5. Any person that wishes to enter the secure area, through an entrance such as a door or the like, must present an access card to be read by the proximity reader of the reader device and receive authorization to enter the secure area. With most proximity readers, data received from the access device such as a card, a key ring element, or the like is validated and either permits the person presenting the access device to enter the secure area by unlocking the entrance or denies entry and does not unlock the entrance.

More specifically, with regard to the function of the reader device 120, a radio frequency (RF) field is generated that surrounds the reader device 120. When an access device is passed through the RF field, a chip inside the access device is excited and transmits data such as an access device number or identification code to the proximity reader device 120. After reading a card, the reader transmits the card information to the local controller 140, in the form of a 32-bit signal.

The local controller 140 controls access to the secure area for a specific proximity reader device 120 and door lock mechanism 130. Since it is not unusual for secure areas to have multiple entrances, in accordance with one embodiment of the present invention the local controller also has the ability to control additional reader devices and associated door lock mechanisms.

The local controller 140 receives the 32-bit signal and determines that the received data is from a proper card. This is done, for example, by the local controller 140 verifying the format of the received signal. If the received signal does not include the format required by the system, the signal is rejected and no access is permitted. Once the local access controller determines that a card is properly associated with the system, the data is forwarded to host computer 160. The host computer 160 determines whether the owner currently associated with the card is allowed access to the secure area. If the use is permitted access to the secure area, a confirmation signal is sent to the local controller 140.

Once the local controller 140 receives the confirmation from the host computer 160, an activation signal is sent to the door lock mechanism 130 to unlock the entrance and to the illumination module 125 to illuminate the integrated reader device 120.

The door lock mechanism 130 can include a bolt mechanism to securely lock the entrance to the secure area. The door lock mechanism 130 can also include any other type of locking device such as a latch lock, or the like, that can be remotely actuated from a locked position to an unlocked position. When the activation signal is received at the door lock mechanism, the bolt mechanism is automatically actuated to an unlocked position, thereby unlocking the entrance and permitting access. When the entrance is once again closed, the bolt mechanism moves back into the locked position to again secure the entrance.

When a confirmation signal is received from the host computer 160 indicating that a person seeking entry to a secure area has proper authorization, a signal is also sent to the an illumination module 125 to illuminate the front face of the integrated reader device 120.

The illumination module 125, which can be a hard wired circuit, receives the confirmation signal from the local access controller 140 and controls the manner in which the integrated reader device 120 is illuminated. As will be discussed in more detail below, the integrated reader device 120 includes a plurality of light emitting diodes (LEDs) that illuminate the glass panel located on the integrated reader device 120. While the LEDs in accordance with the present invention are white, it should be understood that different color LEDs could be employed depending upon, for example, the location of the reader device 120 or the level of security required for entry. Upon receipt of the activation signal, the LEDs can be activated to provide a visual indication to the person attempting to gain entry to the secure area, that access has been granted. The power supply 180 supplies power to the proximity reader device 120 and can also include back-up batteries.

Additionally, the illumination module 125 includes a timer. The timer can be utilized to limit the amount of time the reader device is illuminated. Many known visual indicators are tied into the door lock mechanism which can lead to the indicator being illuminated for unusually long periods of time. For example, if the entrance is kept open for a long period of time after authorization for entry has been granted the visual indicator will be activated for the same length of time. The use of the illumination module 125 with a timer makes the integrated reader device 120 more aesthetically pleasing, saves energy and reduces attention that might be drawn to the open door. The timer device may be implemented to turn the LEDs off after a predetermined amount of time such as five seconds.

In accordance with the present invention, the control system 150 includes the local access controller 140 and the host computer 160 can be implemented via one or more programmed computer systems or devices. While the present invention is embodied by a host computer and a separate local access controller 140, the system of the present invention could also include a system that has a single computer that can be programmed to perform the functions the local access controller 140 and the host computer 160. Accordingly, principles and advantages of distributed processing, such as redundancy, replication, and the like, also can be implemented, as desired, for example, to increase the robustness and performance of the local access controller 140 and the host computer 160.

Additionally, the local access controller 140 and the host computer 160 information relating to various processes described herein can be stored in one or more memories, such as a hard disk, optical disk, magneto-optical disk, RAM, and the like, of the devices and sub-systems of the exemplary systems. One or more databases of the devices and subsystems can store the information used to implement various aspects. The databases can be organized using data structures, such as records, tables, arrays, fields, graphs, trees, lists, and the like, included in one or more memories, such as the memories listed above.

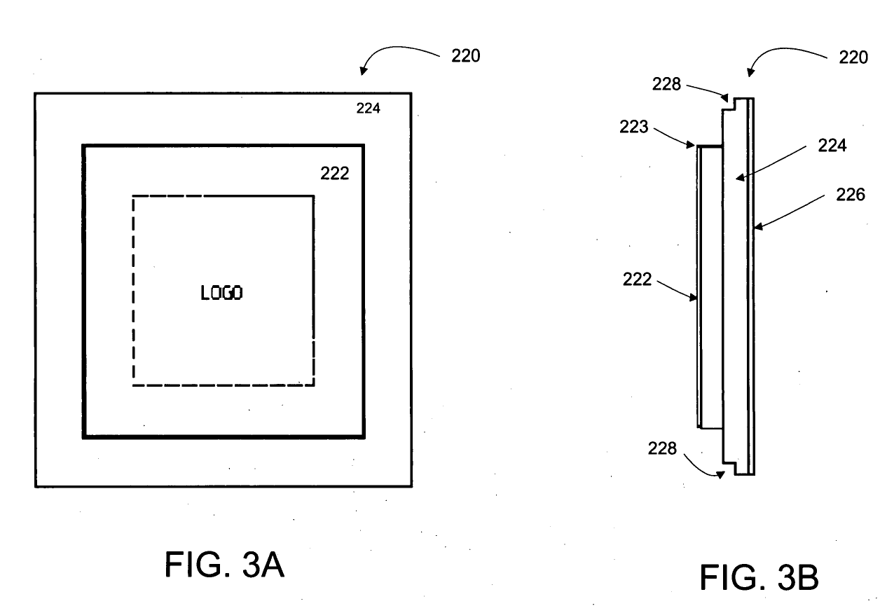

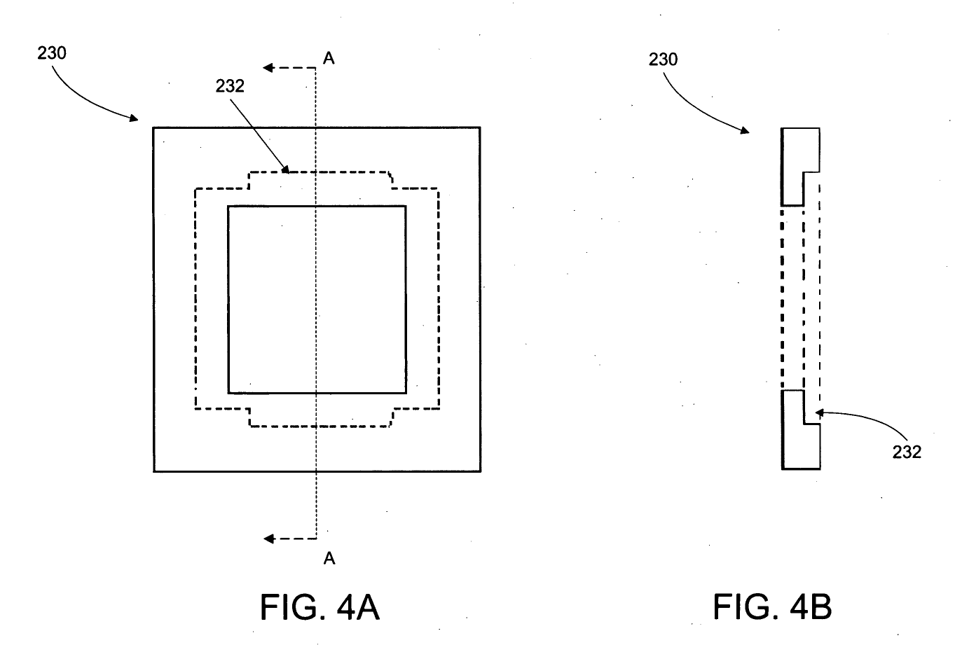

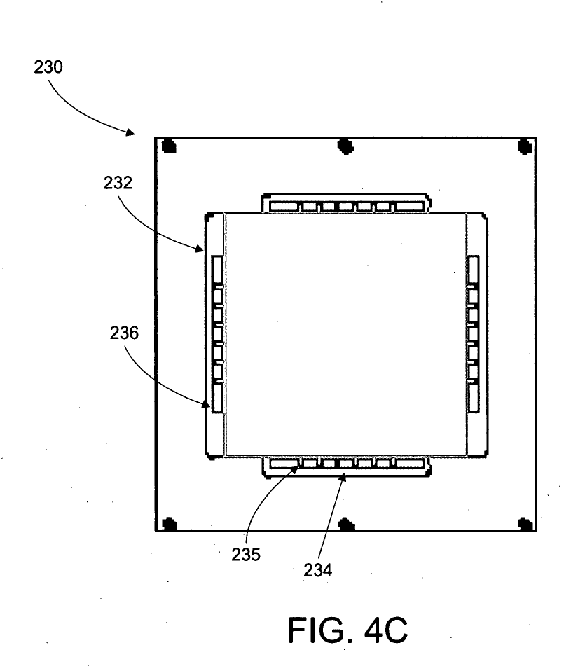

As depicted in the side view illustration of FIG. 2, the integrated reader device 120 of the present invention includes a proximity reader 210, a glass panel 220 (shown in detail in FIGS. 3A and 3B), and a non-metallic frame 230 (shown in detail in FIGS. 4A, 4B and 4C).

The proximity reader 210 can be any off-the-shelf proximity reader, (e.g., by HID, model MaxiProx™) that is able to generate an RF field sufficiently surrounding the proximity reader device so as to be excited by the presentation of an associated access device in the generated RF field.

FIGS. 3A and 3B provide front and side views of the glass panel 220 employed in accordance with the present invention. The glass panel 220 is comprised of two separate glass pieces, a front glass section 222 that can include a beveled edge 223 and a rear glass section 224, that are bonded together. The glass panel 220 additionally includes an acrylic rear piece 226 that provides a black background in the glass panel and provides contrast when the glass panel 220 is illuminated. While the acrylic rear piece, in accordance with the present invention is black, it should be understood that a different color acrylic rear piece could be employed depending upon, for example, the amount of illumination that the reader device is chosen to provide.

The front glass section 222, and the rear glass section 224 (that is larger in size than that of the front glass section) are bonded together with an adhesive. Any conventional adhesive can be employed to bond the front glass section to the rear glass section. However, to ensure the brightest and clearest presentation when illuminated, an optically clear ultra-violet (UV) activated adhesive should be employed. Additionally, the bonding of the two glass sections requires considerable attention in order to avoid trapping any air bubbles between the two glass pieces, thereby reducing the illumination. The rear surface of the rear glass section 224 can, for example, include any kind of custom artwork such as a logo as illustrated in FIG. 3A or other artwork, so that when the glass is illuminated, the artwork is highlighted. In accordance with one exemplary embodiment of the present invention, the front glass section 222 and the rear glass section 224 comprise an optically clear glass such as Borofloat™ or an ofboro-silicate substance. It should also be understood that, in addition to clear glass, different colored glass could also be employed depending upon the desired illumination effects.

In accordance with an exemplary embodiment of the present invention, the rear glass section 224 includes a step 228 carved or milled into the exterior edge of the rear glass section 224. The step 228 carved into the rear glass section of the glass panel provides a support or “catch” so that the glass panel can be mounted within the non-metallic frame 230. In accordance with another exemplary embodiment of the present invention, the top edge of the step 228 could also be beveled.

The non-metallic frame 230, illustrated in FIGS. 4A, 4B and 4C is mounted on the outer periphery of the glass panel (at the step 228). The frame 230 should be non-metallic, or the proximity reader 210 will not read properly. If the frame 230 is metallic, the RF field generated by the proximity reader 210 will be distorted, and the ability to detect access devices will be markedly reduced. In accordance with an exemplary embodiment of the invention, the frame 230 is constructed of medium density fiberboard, although other types of non-metallic materials could be employed to construct the frame. Additionally, while the frame is shown as a unitary device, one of ordinary skill would understand that the frame could be constructed from multiple base elements and assembled in order to construct the frame. The various parts of the frame could be bonded together by an adhesive and/or screws.

The frame 230 includes a step 232 located on its rear side (indicated by hashed lines in FIG. 4A). The step 232 can be created by milling or any other suitable method. FIG. 4B illustrates a side view of the frame shown in FIG. 4A when viewed from the A-A vantage point depicted in FIG. 4A. In the side view of FIG. 4B, the hashed lines represent the interior sides of the frame. The lower area of the frame 230, adjacent to the step 232, is created in order to accommodate placement of LED strips 234 around the sides of the glass panel 220, illustrated in FIG. 4C. Each of the LED strips 234 further includes six (6) individual LEDs 235 which are placed into individual locations in a PC board 236. The placement of the LEDs on the PC board is efficient since this provides a convenient manner of electrically connecting the LEDs, via wires to the LED module 125.

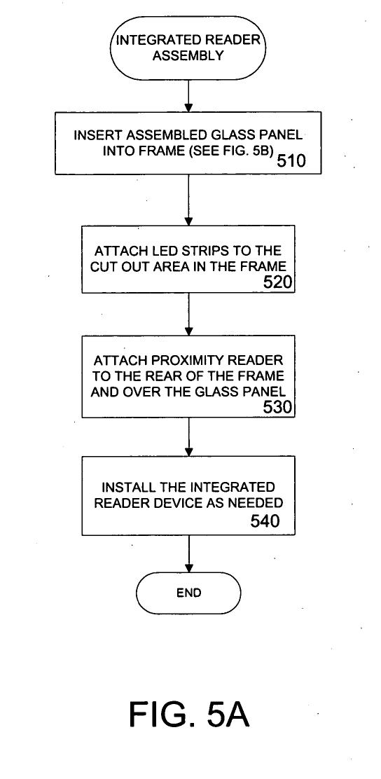

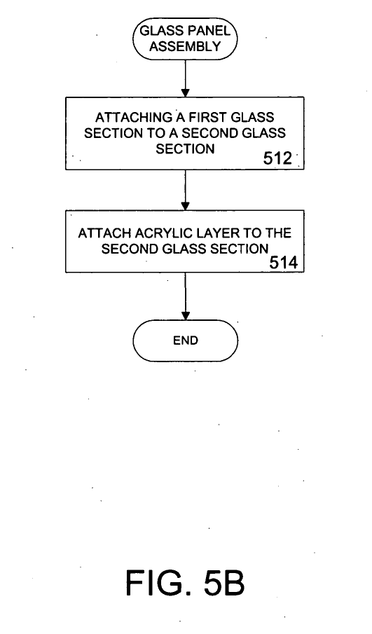

In accordance with another exemplary embodiment of the present invention, and as depicted in the flow diagrams of FIGS. 5A and 5B, the individual elements described above are assembled to create the integrated reader device 120.

The flow diagram of FIG. 5A is directed to assembly of the integrated reader device of the present invention. In step 510, the assembled glass panel is inserted into non-metallic frame 230. Next, in step 520, LED strips 234 are inserted into the milled portion of the frame. As discussed above, the individual LEDs 235 are attached to a PC board 236 to enable electrical connection to exterior circuits. Caution should be taken to ensure that the lenses of the LEDs 135 are laid flat against the edges of the glass and that the strips 234 are centered on the sides and edges of the glass in order to provide the best illumination possible. In step 530, the proximity reader 210 is attached to the rear of the frame 230. The proximity reader 120 can be attached with adhesive as well as with screws. Wires associated with LED strips 234, can be fed through a hole (not illustrated) drilled in the center of the proximity reader covering and the covering can be attached with screws centered on the back of the inner frame. In step 540, the integrated reader device 120 can be installed by attaching the frame of the reader device to the edge of an opening that fits the size of the front glass section.

The flow diagram of FIG. 5B is directed to assembly of the glass panel (with respect to step 510 of FIG. 5A) in accordance with the present invention. In step 512, to assemble the glass panel 220, the first glass section 222 is attached to the second glass section 224 and secured by an adhesive. Next, in step 514, an acrylic layer 226 is attached, through the use of an adhesive, to the second glass section.

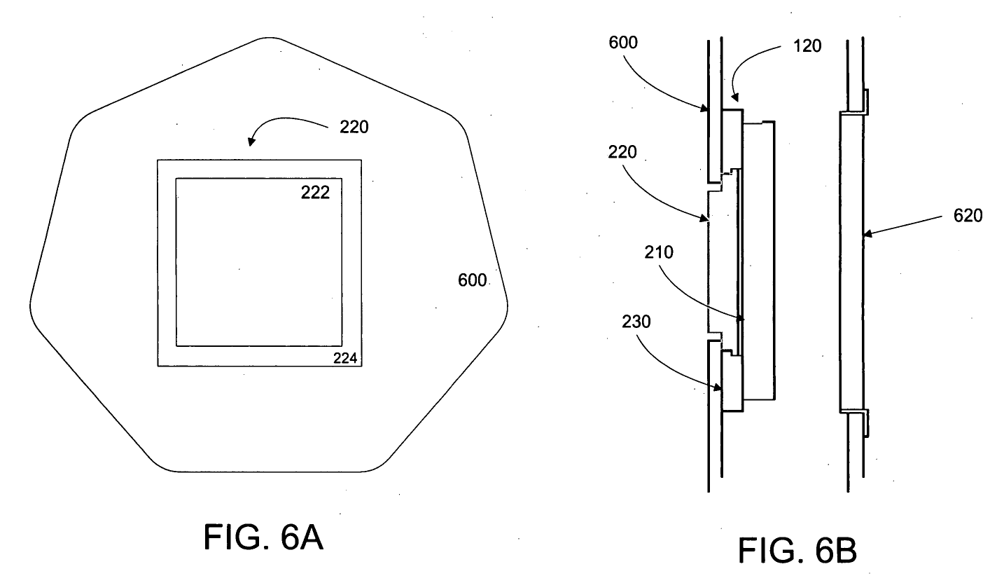

Once the procedures described above with respect to FIGS. 5A and 5B are performed, the reader device 120 can be mounted to a wall 600, as illustrated in FIGS. 6A and 6B. When viewed from the front, as illustrated in FIG. 6A, only the front glass section 222 and the rear glass section 224 of the glass panel 220 are seen by users. The remainder of the reader device 120 is obscured by the wall. Although from the side, illustrated in FIG. 6B, the proximity reader 210 is attached to the frame 230 and the rear piece 226 while the frame is affixed to the wall and to the step located in the rear glass section. A small gap resides between the proximity reader 210 and the glass panel 220. Additionally, FIG. 6B also shows a non-metallic rear access panel that is sometimes needed when the area behind the wall is not large enough for human access. In this situation, the reader device is installed through a rear access panel 610 with the glass centered in a prepared exterior wall cut out.

It is, therefore, apparent that there has been provided, in accordance with the present invention, an integrated reader device that provides access control with regard to a secured area, and more specifically to a method of assembling the integrated reader device for easy and efficient installation adjacent the secured area. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. An integrated reader device for installation near a controlled access entrance, comprising:
a non-metallic mounting frame;
a glass insert mounted on an inside edge of the non-metallic frame;
a proximity reader mounted to one side of said mounting frame and over the glass insert; and
a plurality of LED strips mounted on the inside edge of the non-metallic mounting frame, wherein the integrated reader device is installed on an edge of an opening.

2. The integrated proximity reader device of claim 1, wherein the glass insert further comprises:
a first glass section; and
a second section, wherein the first and second section are bonded together with an adhesive.

3. The integrated proximity reader device of claim 1, wherein the second glass section further comprises:
a step carved on the front edge of the second section, and wherein the mounting frame is attached to the glass insert at the location of the step.

4. The integrated proximity reader device of claim 2, further comprising:
a backing attached via an adhesive to the second glass section of the glass insert, and wherein the backing is acrylic.

5. The integrated proximity reader device of claim 1, wherein said LED strips are positioned flat against the edges of the glass insert and centered on the edge of the glass insert.

6. The integrated reader device of claim 1, wherein the LED strips further comprise:
a plurality of individual LEDs placed in separate locations on a PC board strip.

7. The integrated reader device of claim 1, wherein the LED strips are additionally located so as to fit against the edge of the glass panel.

8. A method for forming and installing an integrated reader device that includes a proximity reader, a glass panel and a non-metallic frame, comprising the steps of:
inserting the glass panel into the non-metallic frame, wherein the glass panel is formed by:
attaching a first glass section to a second glass section via an adhesive, and
attaching an acrylic layer to the second glass section;
attaching a plurality LED strips to the non-metallic frame;
forming the integrated proximity reader by attaching the proximity reader to the acrylic layer of the glass panel and to the frame and ; and
installing the integrated proximity reader on the edge of an opening of a predetermined size.

9. The method of claim 8, wherein the step of installing further comprises:
applying an adhesive to a front the non-metallic frame; and
attaching the adhesive covered frame to the edge of the opening.

10. The method of claim 8, wherein the step of forming further comprises:
drilling a hole in a cover of the proximity reader; and
routing wires associated with the LED strips through the hole for electrical connection.

11. The method of claim 8, wherein the step of inserting further comprises:
attaching the non-metallic frame at the carved step in the edge of the second glass panel.

12. The method of claim 8, wherein the installation of the LEDs further comprises:
mounting individual LEDs inside on a PC board.

13. The method of claim 8, wherein the LED strips are attached to the frame so that lenses of the LEDs lay flat against the edges of the glass panel.

14. The method of claim 8, wherein the adhesive employed to attach the first glass section to the second glass section is a clear adhesive.

15. The method of claim 8, wherein a portion of said non-metallic frame is milled and wherein the LED strips are placed in the milled portion of the non-metallic frame in said attaching step.

16. The method of claim 6, wherein the installation is performed via a rear access panel.
